(19) United States
(12) Patent Application Publication
(10) Pub. No.: US 2015/0254235 A1
(43) Pub. Date: Sep. 10, 2015

(54) Sign Language Translation

(71) Applicant: Boyd Whitley, Snohomish, WA (US)

(72) Inventor: Boyd Whitley, Snohomish, WA (US)

(21) Appl. No.: 14/199,102

(22) Filed: Mar. 6, 2014

(51) Int. Cl. G06F 17/28

(52) U.S. Cl. CPC G06F 17/289

(57) ABSTRACT

The instant application discloses, among other things, techniques to provide for Sign Language Translation. Motion-tracking sensors may attach to a pair of gloves, for example, which may be worn by a user. The sensors may collect data representing a user's movements. A processor may compare the data to information in a database and assign meaning to the movements. Sign Language Translation may provide means for a user to personalize the database to include information about movements unique to a particular user. A transmitter may convey the translated communications as text, voice, Braille, or any other communication form. Sign Language Translation may also allow a user to select or generate a custom voice to transmit the translated communications.

In another embodiment, movement-tracking sensors may attach to bracelets, watches, rings, glasses, depth-sensing cameras, mobile devices, or any other object. In yet another embodiment, Sign Language Translation may utilize visual pattern technology.

### FIELD

This disclosure relates generally to Sign Language Translation.

### BACKGROUND

Sign language is used by millions of people around the world. It may be used to facilitate communications with people with speech or hearing impairments, for example. Sign language may utilize any combination of hand gestures, facial expressions, body movements, touch, and other forms of communication. There are hundreds of types of sign languages, and each language may contain considerable variations.

Often, a person may have difficulty understanding a sign language user. This may be due to, for instance, a lack of fluency in the language, or visibility issues.

### SUMMARY

The instant application discloses, among other things, techniques to provide for Sign Language Translation. In one embodiment, motion-tracking sensors may be embedded in objects such as gloves, for example, which may be worn by a user. The sensors may transmit data points, which represent the user's movements, to a receiver. A processor may compare the data to information in a database and assign meaning to the movements. A transmitter may convey the translated communications as text, voice, or any other communication format.

Sign Language Translation may also provide means for a user to personalize the database to include definitions for movements unique to a particular user. Sign Language Translation may also allow a user to select or generate a custom voice that may be used to transmit the translated communications.

In another embodiment, movement-tracking sensors may attach to glasses, mobile devices, depth-sensing cameras, or any other object. A person skilled in the art will understand that Sign Language Translation may utilize any motion-tracking technology, such as accelerometers, radio-frequency identification (RFID) tags, and infrared lights, for example. In yet another embodiment, Sign Language Translation may utilize visual pattern recognition technology.

Many of the attendant features may be more readily appreciated as they become better understood by reference to the following detailed description considered in connection with the attached drawings.

### BRIEF DESCRIPTION OF THE DRAWINGS

FIG. 1 is a flow diagram illustrating a Sign Language Translation process according to one embodiment.

FIG. 2 is a Sign Language Translation system according to one embodiment.

FIG. 3 is a user interface layout for setting personalization options according to one embodiment.

FIG. 4 is a component diagram of a computing device to which a Sign Language Translation process may be applied according to one embodiment.

Like reference numerals are used to designate like parts in the accompanying drawings.

### DETAILED DESCRIPTION

A more particular description of certain embodiments of Sign Language Translation may be had by references to the embodiments shown in the drawings that form a part of this specification, in which like numerals represent like objects.

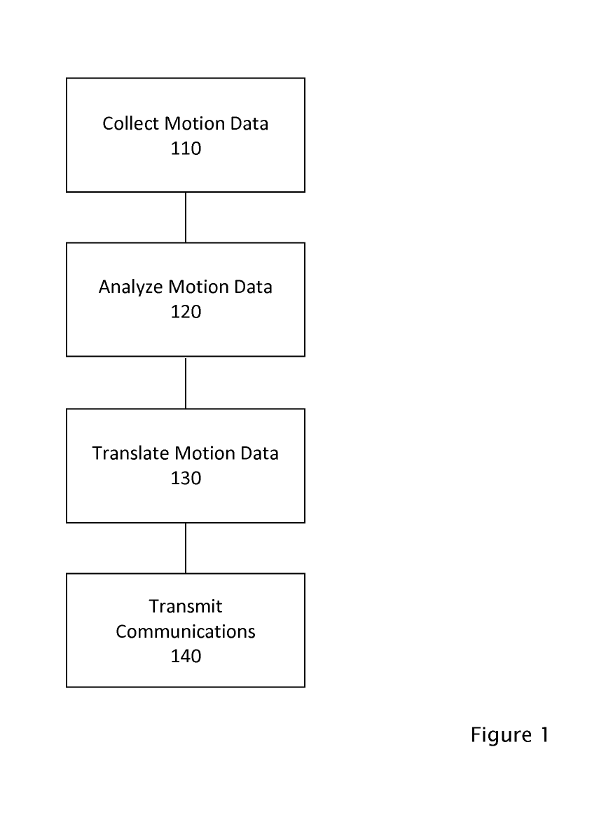

FIG. 1 is a flow diagram illustrating a Sign Language Translation process according to one embodiment. At Collect Motion Data 110, motion-tracking sensors may collect data points representing a user's movements. The movements may include, for example, hand gestures, facial expressions, mouthing (the production of visual syllables with the mouth while signing), and other bodily movements. The sensors may obtain information regarding the distance between body parts, such as fingers or lips, the distance between a user's body and a stationary sensor, or the distance that it takes for light to travel to various body parts from a stationary source, for example. The sensors may also record data about other characteristics such as the intensity and speed of a user's movements. Sign Language Translation may also be configured to collect data on sounds made by a signer.

The sensors may attach to any object, such as gloves, bracelets, watches, rings, glasses, depth-sensing cameras, or mobile devices, for example. Sign Language Translation may utilize any motion-tracking technology, including but not limited to accelerometers, radio-frequency identification (RFID) tags, and infrared lights. In another embodiment, Sign Language Translation may use visual pattern recognition technology.

At Analyze Motion Data 120, a processor may compare the data collected to information in a database to determine the meaning of the movements. The database may include information about one or more unofficial and/or official sign languages, such as American Sign Language, Chinese Sign Language, and Spanish Sign Language, for example. Sign Language Translation may also provide means for a user to personalize the database to include information about movements unique to a particular user. For example, it may allow a person to record motion data and manually assign meanings to the movements in the database. This personalization feature may be useful for a person who uses unconventional or modified methods of signing, for example, a person with physical and/or neurological conditions such as spasticity (the resistance to stretch), spasms, tics, missing body parts such as fingers or limbs, arthritis, or any other characteristics.

At Translate Motion Data 130, a processor may assign meaning to the user's movements based on comparisons between the motion data collected and information stored in the database. The movements may be translated into any communication form, including but not limited to, any spoken or written language that uses words, numbers, characters, or images, or into a tactile language system such as Braille, for example. Sign Language Translation may also be configured to fill in gaps in the translations by, for example, adding words, numbers, characters, images, and punctuation, and rearranging sentences to make them grammatically correct according to standards set forth in the database. Sign Language Translation may also be configured to add indicators of emphasis and emotion, for instance, based on a user's motion data. For example, if a user made big, exaggerated movements, Sign Language Translation may add bold, italics, or capital letters to a translated sentence.

At Transmit Communications 140, the translated motion data may be conveyed in any communication format such as text, voice, images, or tactile graphics such as Braille. For example, the translated communications may be transmitted via text messages on mobile device or by a voice played through a speaker. Sign Language Translation may also allow a user to generate a custom voice, or select a pre-generated voice, to transmit the translated communications.

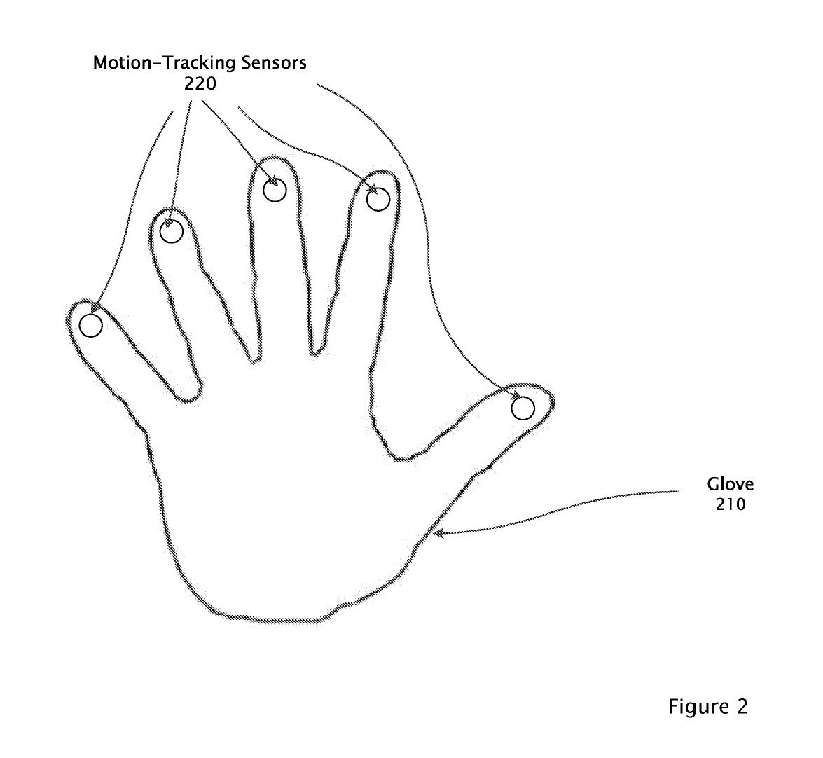

FIG. 2 is a Sign Language Translation system according to one embodiment. In this example, Motion-tracking Sensors 220 may attach to a pair of gloves which may be worn by a user. Motion-tracking Sensors 220 may collect data points representing a user's bodily movements. In this example, Motion-tracking Sensors 220 may collect information about the distance between a user's fingers as well as other characteristics such as the acceleration of a user's movements, for instance. Sign Language Translation may utilize any motion-tracking technology, including but not limited to accelerometers, radio-frequency identification (RFID) tags, and infrared lights. Motion-tracking Sensors 220 may also attach to any object, such as bracelets, watches, rings, glasses, depth-sensing cameras, or mobile devices, for example.

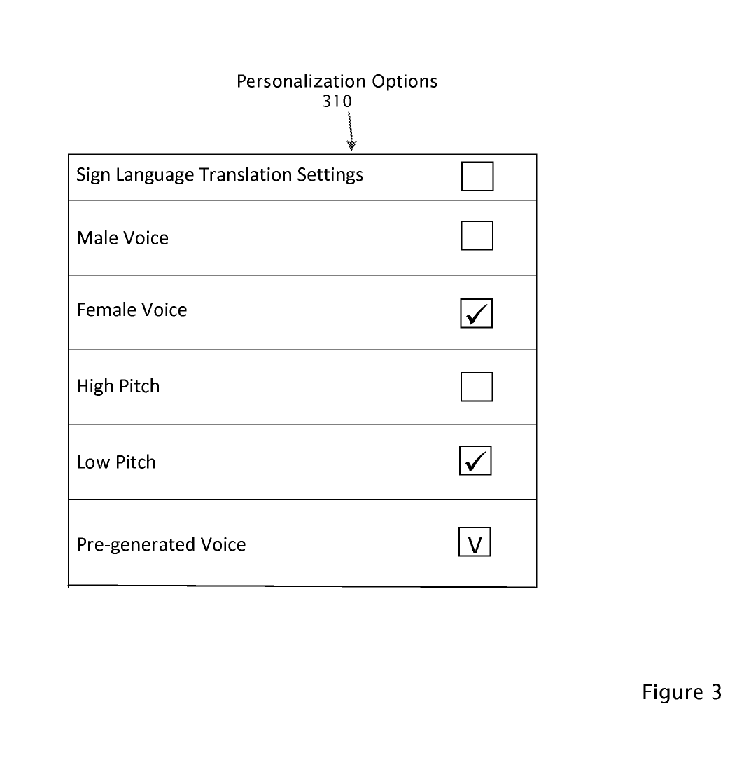

FIG. 3 is a user interface layout for setting Personalization Options 310 according to one embodiment. In this example, a user may generate a custom voice to transmit the translated communications; for example, user may select a male or female voice a high- or low-pitch tone. The user may also select from a drop-down menu of pre-generated voices.

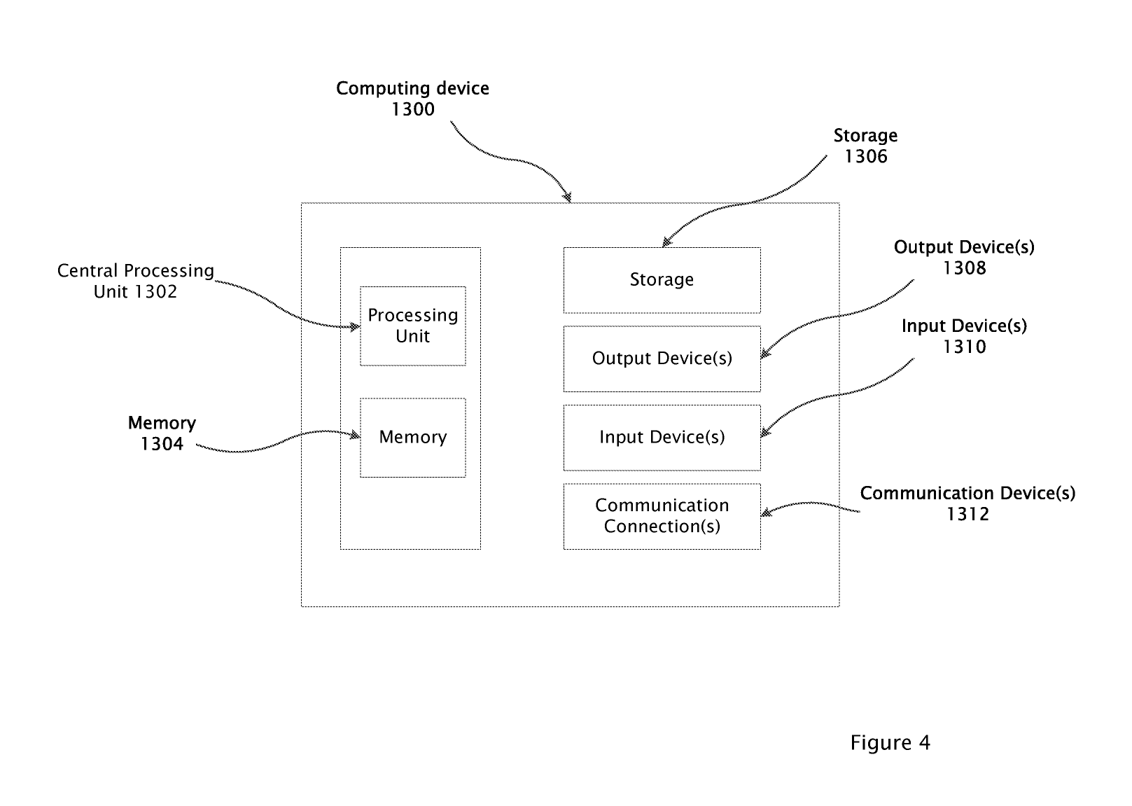

FIG. 4 is a component diagram of a computing device to which a Sign Language Translation process may be applied according to one embodiment. The Computing Device 410 can be utilized to implement one or more computing devices, computer processes, or software modules described herein, including, for example, but not limited to a mobile device. In one example, the Computing Device 410 can be used to process calculations, execute instructions, and receive and transmit digital signals. In another example, the Computing Device 410 can be utilized to process calculations, execute instructions, receive and transmit digital signals, receive and transmit search queries and hypertext, and compile computer code suitable for a mobile device. The Computing Device 410 can be any general or special purpose computer now known or to become known capable of performing the steps and/or performing the functions described herein, either in software, hardware, firmware, or a combination thereof.

In its most basic configuration, Computing Device 410 typically includes at least one Central Processing Unit (CPU) 420 and Memory 430. Depending on the exact configuration and type of Computing Device 410, Memory 430 may be volatile (such as RAM), non-volatile (such as ROM, flash memory, etc.) or some combination of the two. Additionally, Computing Device 410 may also have additional features/functionality. For example, Computing Device 410 may include multiple CPU's. The described methods may be executed in any manner by any processing unit in computing device 410. For example, the described process may be executed by both multiple CPU's in parallel.

Computing Device 410 may also include additional storage (removable and/or non-removable) including, but not limited to, magnetic or optical disks or tape. Such additional storage is illustrated in FIG. 5 by Storage 440. Computer readable storage media includes volatile and nonvolatile, removable and non-removable media implemented in any method or technology for storage of information such as computer readable instructions, data structures, program modules or other data. Memory 430 and Storage 440 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 410. Any such computer readable storage media may be part of computing device 410. But computer readable storage media does not include transient signals.

Computing Device 410 may also contain Communications Device(s) 470 that allow the device to communicate with other devices. Communications Device(s) 470 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device 410 may also have Input Device(s) 460 such as keyboard, mouse, pen, voice input device, touch input device, etc. Output Device(s) 450 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used.

Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A Sign Language Translation method, comprising, on a computer:
collecting motion data;
comparing motion data to a database of definitions;
assigning meanings to the collected motion data;
converting motion data into other communication forms;
transmitting the translated communications.

2. The method of claim 1, wherein the collecting motion data comprises collecting data points using motion-tracking sensors.

3. The Sign Language Translation of claim 1, wherein collecting motion data comprises determining the distance light travels from a stationary source.

4. The Sign Language Translation of claim 1, wherein collecting motion data comprises obtaining data from a plurality of radio-frequency identification (RFID) tags.

5. The Sign Language Translation of claim 1, wherein collecting motion data comprises obtaining data from an accelerometer.

6. The Sign Language Translation of claim 1, wherein collecting motion data involves converting data into electronic pulses.

7. The Sign Language Translation of claim 1, wherein collecting motion data comprises utilizing visual pattern recognition technology.

8. A Sign Language Translation system, comprising:
a processor;
a memory coupled to the processor;
components operable on the processor, comprising:
a motion data collection component, configured to obtain information about a user's movements;
a motion data comparison component, configured to compare the collected motion data with information in a database;
a meaning assignment component, configured to assign meanings to the collected motion data;
a motion data conversion component, configured to translate the collected motion data into other communication forms;
a transmission component, configured to transmit the translated communications.
